(19) United States
(12) Patent Application Publication
(10) Pub. No.: US 2017/0126831 A1
(43) Pub. Date: May 4, 2017

(54) METHODS AND SYSTEMS FOR CACHING A MEDIA ASSET

(71) Applicant: Rovi Guides, Inc., Santa Clara, CA (US)

(72) Inventors: Chelakara S. Prakash, San Jose, CA (US); Shane A. Martin, Tulsa, OK (US); Darren May, Sunnyvale, CA (US); Walter R. Klappert, Los Angeles, CA (US)

(21) Appl. No.: 14/927,681

(22) Filed: Oct. 30, 2015

(51) Int. Cl. H04L 29/08; H04N 21/231; H04N 21/436; H04W 84/12

(52) U.S. Cl. CPC H04L 67/2842; H04L 67/12; H04W 84/12; H04N 21/23106; H04N 21/43615; H04N 21/23113

(57) ABSTRACT

Methods and systems for caching a media asset implemented on a user equipment device. The user equipment device is connected to a home network including the user equipment device and a mobile device. The media asset may be transformed into a first portion that is likely to be accessed and a second portion that is not likely to be accessed. The first portion may be stored at a user equipment device. The second portion may be stored at the mobile device. The home network may implement a custom Wi-Fi protocol that allows a first device on the home network to query a second device for an amount of storage space available on the second device. The user equipment device and the mobile device may each include a software driver compatible with the custom Wi-Fi protocol.

### BACKGROUND OF THE INVENTION

In conventional systems, users may access a wide variety of media content from different sources, such as a broadcast network, a cable network, or the Internet. Retrieving media content from the Internet typically requires a high bandwidth Internet connection as well as significant storage space on the connected device to at least temporarily store the retrieved media content. In conventional systems lacking a high bandwidth connection, such conventional systems can retrieve media content in advance of when the user is expected to view the media content. However, conventional systems may lack the storage space necessary to temporarily store the retrieved media content until the user has an opportunity to view the media content.

### SUMMARY

Accordingly, methods and systems are disclosed herein for an interactive media guidance application, implemented on a user equipment device, that caches media assets on another device available in the same network. For example, a user equipment device, such as a smart television, may not have sufficient storage space available to store a movie trailer that the interactive media guidance application retrieved for caching. In this example, the interactive media guidance application may select a mobile device in the user's home network for caching and store the movie trailer on the mobile device. The interactive media guidance application may retrieve the movie trailer from the mobile device when the user requests playback of the movie trailer on their smart television.

The interactive media guidance application may be implemented on a user equipment device, such as a smart television, a set top box, a dongle (a small piece of hardware) or another suitable user equipment device. Though the embodiments disclosed herein typically refer to a smart television, the embodiments may be applied to any other suitable user equipment device. The interactive media guidance application may select one or more suitable caching devices in the same network as the user equipment device, such as a mobile device, a tablet device, computer equipment or any other suitable caching device. Similarly, though the embodiments disclosed herein typically refer to a mobile device, the embodiments may be applied to any other suitable caching device. Similarly, though the embodiments disclosed herein typically refer to a home network, the embodiments may be applied to any other suitable network that includes the user equipment device and one or more caching devices.

In some embodiments, a smart television having a modest memory size may be located, e.g., in Asia or Africa, a long distance from a media content source, e.g., a media server located in Tulsa, Okla. The interactive media guidance application, implemented on the smart television, may receive an instruction to store some frequently needed data, data the user is expected to access, or other data suitable for caching. After the smart television's memory is full, the interactive media guidance application may search for personal devices in the home network to cache data and improve the user's viewing experience. Alternatively, the interactive media guidance application may search for personal devices in the home network before the smart television's memory is full.

For example, a user living in Namibia (southwest Africa) may purchase a new smart television. As the user is setting up the smart television within their home network, the interactive media guidance application implemented on the smart television may detect a mobile phone and/or a tablet computer in the user's Wi-Fi network. The interactive media guidance application may prompt the user to allow use of memory on one or both devices, e.g., 500 MB of memory from each of those devices, to store data, such as poster art, movie trailers, and other suitable data. The user may be especially motivated to consent to the prompt if they have issues with buffering media content from the distant media server.

In some embodiments, the interactive media guidance application determines availability of a caching device in the user's home network. For example, the interactive media guidance application may periodically send a ping request to a caching device to detect whether it is present in the user's home network. If the caching device does not return a response to the ping request, the interactive media guidance application may store an indication that the caching device is unavailable. If the caching device returns a response to the ping request, the interactive media guidance application may store an indication that the caching device is available. The interactive media guidance application may store data, such as guidance data or media content, on the caching device based on its availability.

For example, after monitoring availability of the caching device for a certain period of time, the interactive media guidance application may determine that the caching device is only available during the day. The interactive media guidance application may send instructions to only store data on the caching device that is needed during the day. In another example, after monitoring availability of the caching device for a certain period of time, the interactive media guidance application may determine that the caching device is only available during the night. The interactive media guidance application may send instructions to only store data on the caching device that is needed during the night.

In yet another example, the interactive media guidance application may receive calendar information from a caching device, such as a mobile device, in the user's home network. The interactive media guidance application may determine whether to store data, such as guidance data or media content, on the caching device based on its availability in the calendar information. For example, if the calendar information indicates that the user is going to be at an event during a certain time, the interactive media guidance application may not store data needed during that time on the mobile device. In another example, if the calendar information indicates that the user is going to be at home during a certain time, the interactive media guidance application may store data needed during that time on the mobile device.

For example, the interactive media guidance application may detect the user's mobile phone and tablet device in the home network. The interactive media guidance application may determine that the tablet device is always available in the home network, e.g., because the user does not carry the tablet device outside of their home. On the other hand, the interactive media guidance application may determine that the mobile phone is only available in the home network during nights and weekends, e.g., because the user carries the mobile phone with them during the day at work. The interactive media guidance application may store data needed at night or on the weekends in the mobile phone, while the interactive media guidance application may store data needed during the day or data needed at a later unspecified time (e.g., the user is expected to watch a particular program at some later time) in the tablet device. The interactive media guidance application may choose the caching device based on the availability of the caching device as well as the persistence of the data being stored, i.e., whether the data is being stored for short-term or long-term usage or whether the data is more or less likely to be accessed at a given time.

In some embodiments, the interactive media guidance application communicates with potential caching devices, such as mobile phones and tablet devices, in the user's wireless network via, e.g., the IEEE 802.11 protocol or another suitable wireless networking protocol. In the case of the IEEE 802.11 protocol, the wireless protocol includes a specification for implementing wireless local area network communication in wireless frequency bands, such as 2.4 GHz, 3.6 GHz, 5 GHz, 60 GHz, or another suitable frequency band. The security features of the IEEE 802.11 protocol may not allow the interactive media guidance application to query potential caching devices for information to determine suitability of the caching device, such as available storage space, calendar information, or other suitable information. In some embodiments, the user installs a software application on, e.g., a mobile device, connected to the user's home network. The software application may be paired with, e.g., the user's smart television, running the interactive media guidance application. The software application may request the necessary permissions from the user to retrieve information needed to determine suitability for caching. The interactive media guidance application may communicate with the software application to retrieve this information.

In some embodiments, the interactive media guidance application, running on the user's smart television, prompts the user to designate a caching device and requests the user to connect a mobile device to the smart television via a physical connection, e.g., using a universal serial bus (USB) port or another suitable interface. The interactive media guidance application may install a software application on the mobile device. The interactive media guidance application may communicate with the software application to retrieve information needed to determine suitability for caching. After the software application is installed on the mobile device, the interactive media guidance application may communicate with the software application via the user's home network. The physical connection between the smart television and the mobile device may be severed in this case.

In some embodiments, the user's home network sets up communication between the smart television and the mobile device via a custom wireless protocol. For example, the 802.11 wireless protocol may be modified to allow the smart television to retrieve information from the mobile device needed to determine suitability of the mobile device for caching. Such a non-IEEE standard 802.11 feature extends functionality of the 802.11 wireless protocol and may be implemented as a proprietary feature. For example, chipmaker ATHEROS implemented a proprietary channel bonding feature for manufacturers of access points and client cards for boosting network speeds and increased network range. The custom wireless protocol may allow the interactive media guidance application to retrieve needed information from the mobile device without installing a software application on the mobile device. The custom wireless protocol may limit access of such information to verified entities, such as the interactive media guidance application, and deny requests from other unverified entities.

In some embodiments, the data stored on any caching device may be removed when the caching device leaves the user's home network. The cached data may be removed to maintain security of any important information, such as the user's identification. If an authorized entity were to attempt to access the cached data after the device has left the user's home network, such an entity will be unable to retrieve any such information. For example, the user may take a mobile device out of the home network and lose the mobile device while away from the home. In such a case, any unauthorized entity attempting to access the cached data on the mobile device may not be able to retrieve any important information that was potentially stored in the cached data.

In some aspects, the interactive media guidance application is implemented on control circuitry of a user equipment device connected to a home network. The home network includes the user equipment device and a mobile device. The interactive media guidance application receives an instruction to cache a media asset at the user equipment device. The interactive media guidance application determines whether the user equipment device has a sufficient amount of storage available to store the media asset. In response to determining that the user equipment device does not have the sufficient amount of storage available to store the media asset, the interactive media guidance application transforms the media asset into a first portion and a second portion. The interactive media guidance application retrieves the first portion of the media asset. The interactive media guidance application stores the first portion of the media asset at the user equipment device. The interactive media guidance application detects the mobile device in the home network. The interactive media guidance application retrieves an amount of storage available on the mobile device. The interactive media guidance application determines whether the amount of storage available on the mobile device is sufficient to store the second portion of the media asset. In response to determining that the amount of storage available is sufficient to store the second portion of the media asset, the interactive media guidance application retrieves the second portion of the media asset. The interactive media guidance application transfers the second portion of the media asset to the mobile device.

In some embodiments, the home network implements a custom Wi-Fi protocol. The custom Wi-Fi protocol allows a first device on the home network to query a second device for an amount of storage space available on the second device. The user equipment device and the mobile device each include a software driver compatible with the custom Wi-Fi protocol. The interactive media guidance application generates a query for retrieving the amount of storage available on the mobile device according to the custom Wi-Fi protocol. The interactive media guidance application transmits the query to the mobile device.

In some embodiments, the home network implements a standard Wi-Fi protocol. The user equipment device and the mobile device each include a custom application that allows a first device on the home network to query a second device for an amount of storage space available on the second device. The interactive media guidance application generates a query for retrieving the amount of storage available on the mobile device via the custom application on the user equipment device. The interactive media guidance application transmits the query to the custom application on the mobile device from the custom application on the user equipment device.

In some embodiments, the custom application is installed on the mobile device via an Internet connection.

In some embodiments, the custom application is installed on the mobile device via a physical connection to the user equipment device.

In some embodiments, the interactive media guidance application detects at periodic intervals whether the mobile device is available in the home network. The interactive media guidance application stores in a database information regarding availability of the mobile device in the home network. The interactive media guidance application determines whether the availability of the mobile device in the home network is below a threshold. In response to determining that the availability of the mobile device in the home network is below the threshold, the interactive media guidance application detects an additional mobile device in the home network. The interactive media guidance application retrieves an amount of storage available on the additional mobile device. The interactive media guidance application determines whether the amount of storage available on the additional mobile device is sufficient to store the second portion of the media asset. In response to determining that the amount of storage available is sufficient to store the second portion of the media asset, the interactive media guidance application retrieves the second portion of the media asset. The interactive media guidance application transfers the second portion of the media asset to the additional mobile device.

In some embodiments, the interactive media guidance application detects at periodic intervals whether the mobile device is available in the home network. The interactive media guidance application stores in a database information regarding availability of the mobile device in the home network. The interactive media guidance application determines whether the availability of the mobile device in the home network exceeds a threshold. The interactive media guidance application transfers the second portion of the media asset to the mobile device in response to determining that the availability of the mobile device in the home network exceeds the threshold and that the amount of storage available is sufficient to store the second portion of the media asset.

In some embodiments, the threshold is related to an expected time when the cached media asset will be retrieved from the mobile device. In this manner, the interactive media guidance application may choose the caching device based on the availability of the caching device as well as the persistence of the data being stored, i.e., whether the data is being stored for short-term or long-term usage or whether the data is more or less likely to be accessed at a given time.

In some embodiments, the interactive media guidance application designates one or more segments of the media asset likely to be accessed as the first portion. The interactive media guidance application designates one or more segments of the media asset not likely to be accessed as the second portion.

In some embodiments, the interactive media guidance application transmits an instruction to the mobile device to delete the second portion of the media asset when the mobile device disconnects from the home network.

It should be noted that the systems, methods, apparatuses, and/or aspects described above may be applied to, or used in accordance with, other systems, methods, apparatuses, and/or aspects.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a display screen generated by a media guidance application in accordance with some embodiments of the disclosure;

FIG. 2 shows another illustrative example of a display screen generated by a media guidance application in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 is a flowchart of illustrative steps for selecting a mobile device in a home network for caching a media asset in accordance with some embodiments of the disclosure;

FIG. 6 is pseudocode of illustrative steps for selecting a mobile device in a home network for caching a media asset in accordance with some embodiments of the disclosure;

FIG. 7 is a flowchart of an illustrative process for using a database to select a mobile device in a home network for caching a media asset in accordance with some embodiments of the disclosure;

FIG. 8 is pseudocode of an illustrative process for using a database to select a mobile device in a home network for caching a media asset in accordance with some embodiments of the disclosure;

FIG. 9 is a block diagram of a system for caching media assets in a home network in accordance with some embodiments of the disclosure;

FIG. 10 is a diagram of a display relating to caching media assets in a home network in accordance with some embodiments of the disclosure;

FIG. 11 is a diagram of another display relating to caching media assets in a home network in accordance with some embodiments of the disclosure;

FIG. 12 is a diagram of yet another display relating to caching media assets in a home network in accordance with some embodiments of the disclosure;

FIG. 13 is a flowchart of an illustrative process for caching media assets in a home network in accordance with some embodiments of the disclosure; and

FIG. 14 is a flowchart of another illustrative process for caching media assets in a home network in accordance with some embodiments of the disclosure.

### DETAILED DESCRIPTION

Methods and systems for caching a media asset implemented on a user equipment device are described. In some aspects, the user equipment device is connected to a home network including the user equipment device and a mobile device. The media asset may be transformed into a first portion that is likely to be accessed and a second portion that is not likely to be accessed. The first portion may be stored at a user equipment device. The second portion may be stored at the mobile device. The home network may implement a custom Wi-Fi protocol that allows a first device on the home network to query a second device for an amount of storage space available on the second device. The user equipment device and the mobile device may each include a software driver compatible with the custom Wi-Fi protocol.

The media guidance application may be implemented on a user equipment device, such as a smart television, a set top box, a dongle (a small piece of hardware) or another suitable user equipment device. Though the embodiments disclosed herein typically refer to a smart television, the embodiments may be applied to any other suitable user equipment device. The media guidance application may select one or more suitable caching devices in the same network as the user equipment device, such as a mobile device, a tablet device, computer equipment or any other suitable caching device. Similarly, though the embodiments disclosed herein typically refer to a mobile device, the embodiments may be applied to any other suitable caching device. Similarly, though the embodiments disclosed herein typically refer to a home network, the embodiments may be applied to any other suitable network that includes the user equipment device and one or more caching devices.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase “media guidance data” or “guidance data” should be understood to mean any data related to content or data used in operating the guidance application. For example, the guidance data may include program information, guidance application settings, user preferences, user profile information, media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

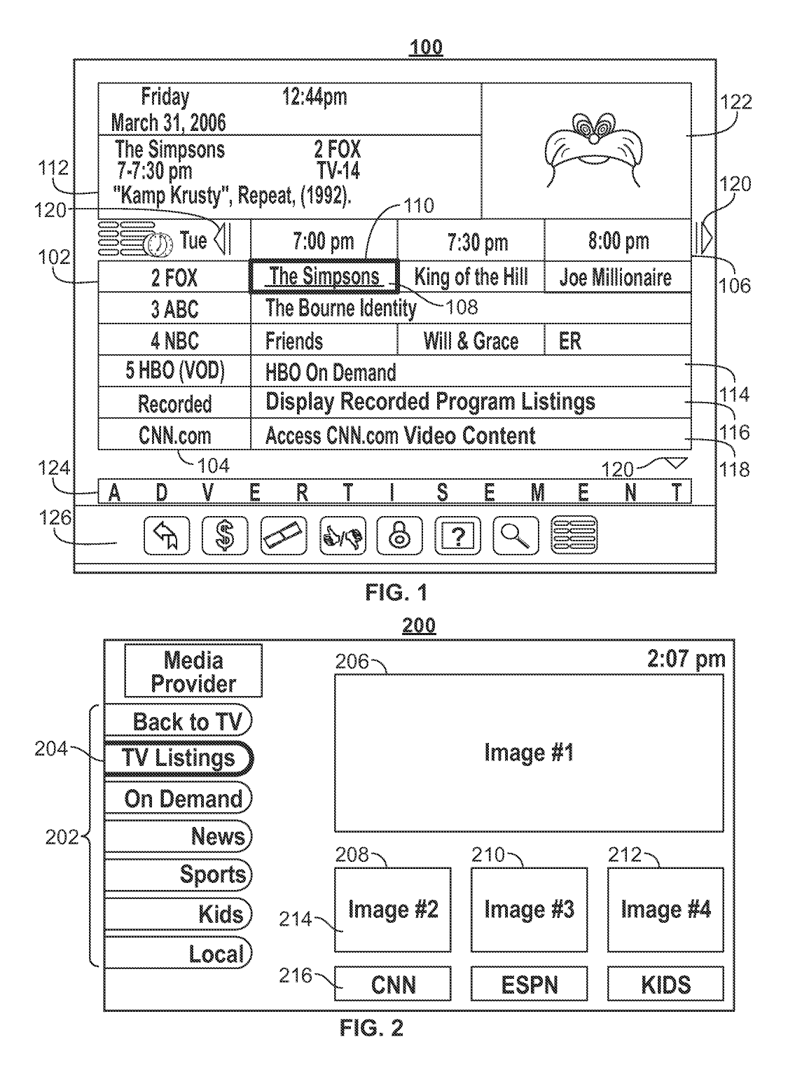

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria.

FIG. 1 shows illustrative grid of a program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Nov. 12, 2009, which is hereby incorporated by reference herein in its entirety.

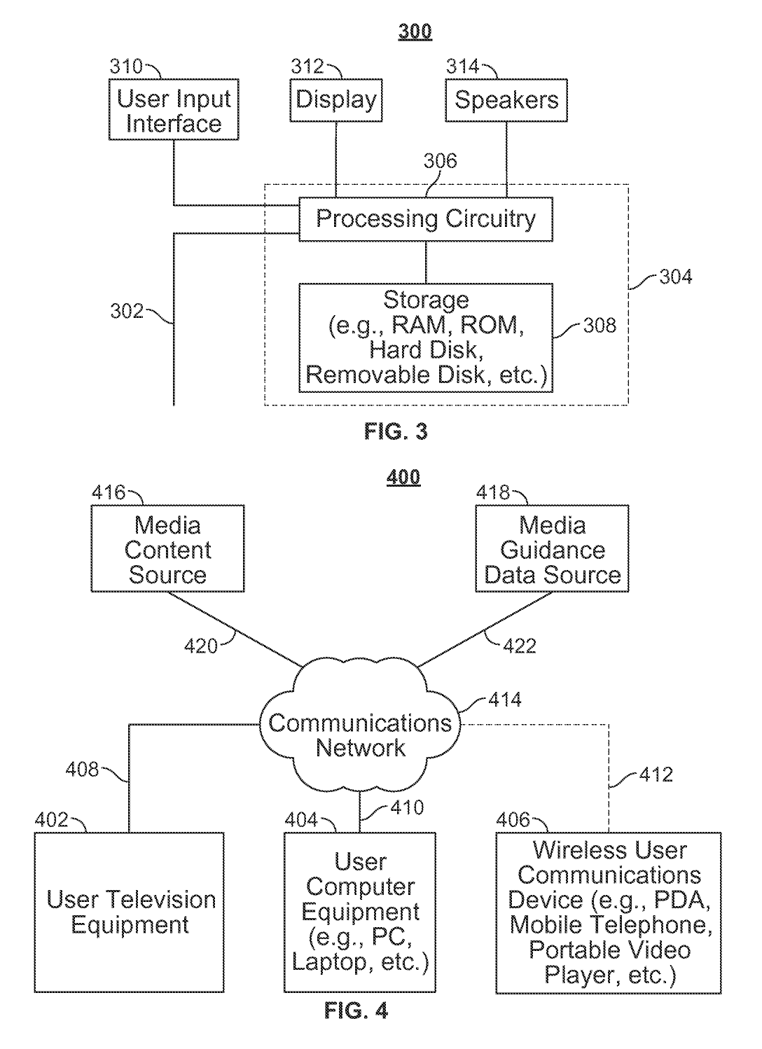

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 310 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly-implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

In some embodiments, the media guidance data may include viewer data. For example, the viewer data may include current and/or historical user activity information (e.g., what content the user typically watches, what times of day the user watches content, whether the user interacts with a social network, at what times the user interacts with a social network to post information, what types of content the user typically watches (e.g., pay TV or free TV), mood, brain activity information, etc.). The media guidance data may also include subscription data. For example, the subscription data may identify to which sources or services a given user subscribes and/or to which sources or services the given user has previously subscribed but later terminated access (e.g., whether the user subscribes to premium channels, whether the user has added a premium level of services, whether the user has increased Internet speed). In some embodiments, the viewer data and/or the subscription data may identify patterns of a given user for a period of more than one year. The media guidance data may include a model (e.g., a survivor model) used for generating a score that indicates a likelihood a given user will terminate access to a service/source. For example, the media guidance application may process the viewer data with the subscription data using the model to generate a value or score that indicates a likelihood of whether the given user will terminate access to a particular service or source. In particular, a higher score may indicate a higher level of confidence that the user will terminate access to a particular service or source. Based on the score, the media guidance application may generate promotions and advertisements that entice the user to keep the particular service or source indicated by the score as one to which the user will likely terminate access.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. Patent Publication No. 2005/0251827, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

As referred herein, the term “in response to” refers to initiated as a result of. For example, a first action being performed in response to another action may include interstitial steps between the first action and the second action. As referred herein, the term “directly in response to” refers to caused by. For example, a first action being performed directly in response to another action may not include interstitial steps between the first action and the second action.

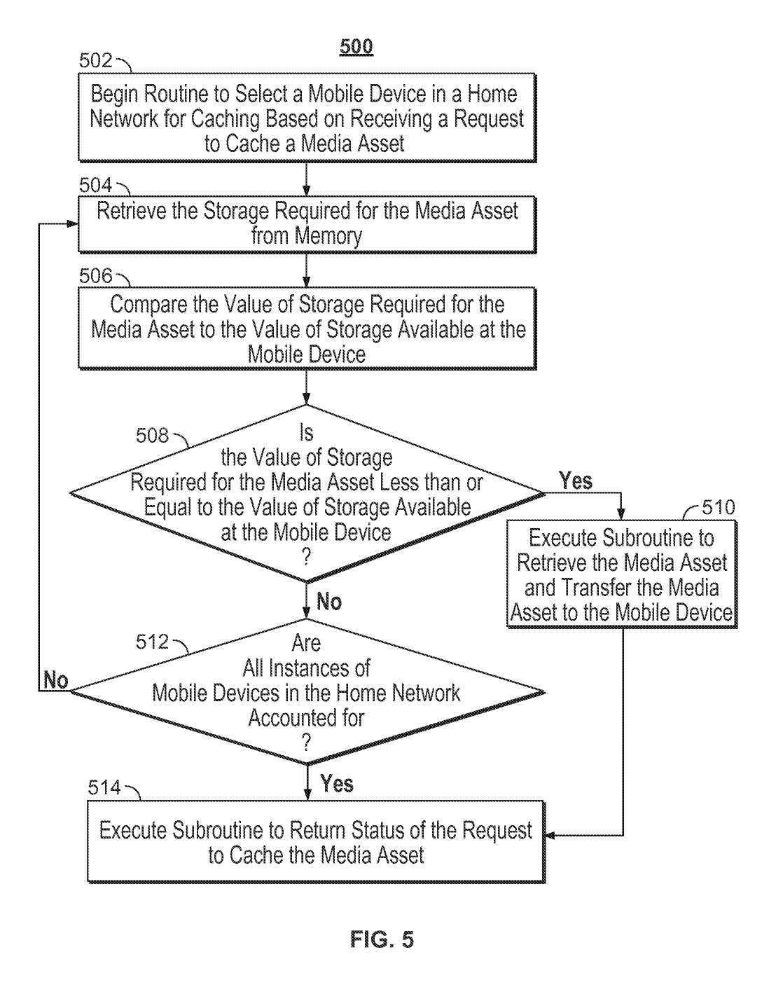

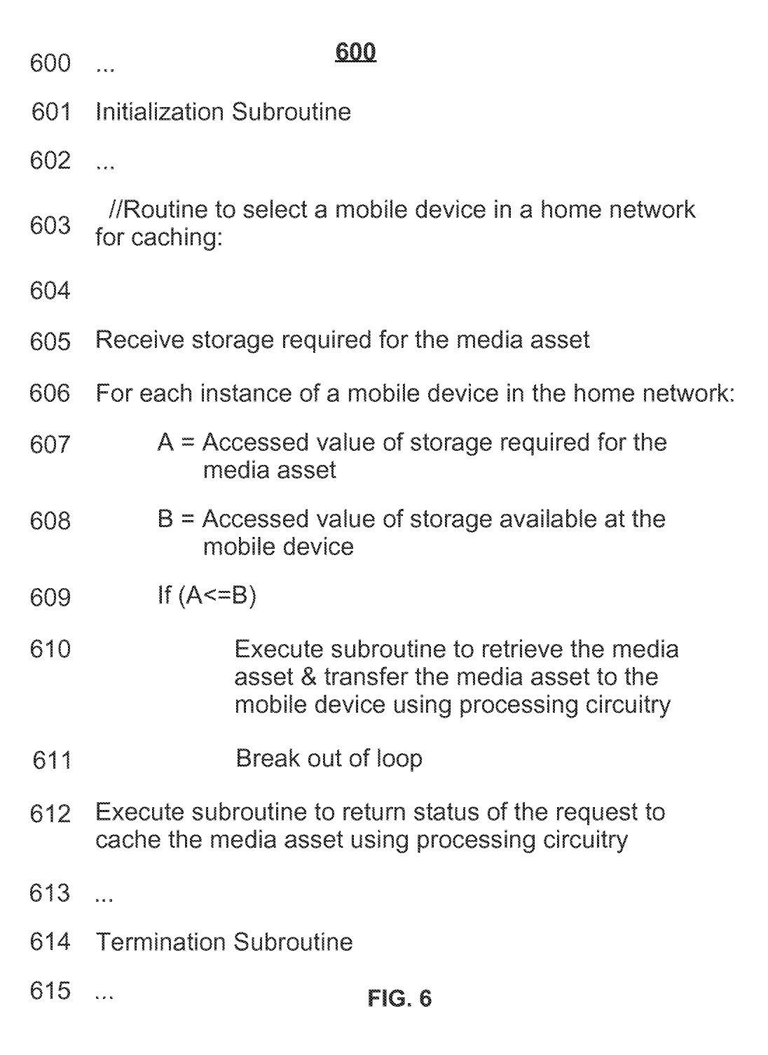

FIGS. 5 and 6 present an algorithm for control circuitry (e.g., control circuitry 304) to select a mobile device in a home network for caching a media asset in accordance with some embodiments of the disclosure. In some embodiments this algorithm may be encoded on to non-transitory storage medium (e.g., storage device 308) as a set of instructions to be decoded and executed by processing circuitry (e.g., processing circuitry 306). Processing circuitry may in turn provide instructions to other sub-circuits contained within control circuitry 304, such as the tuning, video generating, encoding, decoding, encrypting, decrypting, scaling, analog/digital conversion circuitry, and the like.

The flowchart in FIG. 5 describes a process implemented on control circuitry (e.g., control circuitry 304) to select a mobile device in a home network for caching a media asset in accordance with some embodiments of the disclosure.

At step 502, control circuitry 304 begins a routine to select a mobile device in a home network for caching a media asset based on receiving a request to cache a media asset. In some embodiments, this may be done either directly or indirectly in response to a user action or input (e.g., from signals received by control circuitry 304 or user input interface 310). For example, the process may begin directly in response to control circuitry 304 receiving signals from user input interface 310, or control circuitry 304 may prompt the user to confirm their input using a display (e.g., by generating a prompt to be displayed on display 312) prior to running the algorithm.

At step 504, control circuitry 304 proceeds to retrieve the storage required for the media asset from memory. In some embodiments control circuitry 304 may receive a single primitive data structure that represents the value of the storage required for the media asset. In some embodiments the value may be stored as part of a larger data structure, and control circuitry 304 may retrieve the value by executing appropriate accessor methods to retrieve the value from the larger data structure.

At step 506, control circuitry 304 proceeds to compare the value of storage required for the media asset to the value of storage available at the mobile device. In some embodiments, the value of storage available at the mobile device may be stored (e.g., on storage device 308) prior to beginning the process. In some embodiments, control circuitry 304 may directly compare the value of storage available at the mobile device with the value of storage required for the media asset by accessing the values respectively from memory and performing a value comparison. In some instances, control circuitry 304 may call a comparison function (e.g., for object to object comparison) to compare the storage required for the media asset and the storage available at the mobile device.

At step 508, control circuitry 304 compares the values of the storage required for the media asset and the storage available at the mobile device to determine if the value of the storage required for the media asset is less than or equal to the value of the storage available at the mobile device. If the condition is satisfied, the algorithm may proceed to step 510; if the condition is not satisfied, the algorithm may proceed to step 512 instead.

At step 510, control circuitry 304 executes a subroutine to retrieve the media asset and transfer the media asset to the mobile device based on the condition at step 508 being satisfied. After the subroutine is executed, the algorithm may proceed to step 514 where control circuitry 304 executes a subroutine to return status of the request to cache the media asset.

At step 512, control circuitry 304 checks if all instances of mobile devices in the home network are accounted for. If all of the instances have been evaluated, control circuitry 304 may proceed to step 514. For example, control circuitry 304 may call a function to see if there is another mobile device available in the home network. If the function returns true (i.e., there are still instances that need to be processed), control circuitry 304 may proceed to step 504.

At step 514, control circuitry 304 executes a subroutine to return status of the request to cache the media asset.

It is contemplated that the descriptions of FIG. 5 may be used with any other embodiment of this disclosure. In addition, the descriptions described in relation to the algorithm of FIG. 5 may be done in alternative orders or in parallel to further the purposes of this disclosure. For example, conditional statements and logical evaluations may be performed in any order or in parallel or simultaneously to reduce lag or increase the speed of the system or method. As a further example, in some embodiments several instances of mobile devices in the home network may be evaluated in parallel, using multiple logical processor threads or the algorithm may be enhanced by incorporating branch prediction. Furthermore, it should be noted that the process of FIG. 5 may be implemented on a combination of appropriately configured software and hardware, and that any of the devices or equipment discussed in relation to FIGS. 3-4 could be used to implement one or more portions of the process.

The pseudocode in FIG. 6 describes a process to select a mobile device in a home network for caching in accordance with some embodiments of the disclosure. It will be evident to one skilled in the art that the process described by the pseudocode in FIG. 6 may be implemented in any number of programming languages and a variety of different hardware, and that the style and format should not be construed as limiting, but rather a general template of the steps and procedures that would be consistent with code used to implement some embodiments of this disclosure.

At line 601, control circuitry 304 runs a subroutine to initialize variables and prepare to select a mobile device in the home network for caching, which begins on line 605. For example, in some embodiments control circuitry 304 may copy instructions from non-transitory storage medium (e.g., storage device 308) into RAM or into the cache for processing circuitry 306 during the initialization stage. Additionally, in some embodiments the value of storage available at the mobile device being used for comparison, or a tolerance level for determining if two values are essentially equivalent, may be retrieved, set, and stored at 601.

At line 605, control circuitry 304 receives the value of the storage required for the media asset. In some embodiments these instances may be retrieved from memory. Control circuitry 304 may receive the value of the storage required for the media asset by receiving, for example, a pointer to an array of values of storage for multiple media assets. In another example, control circuitry 304 may receive an object of a class, such as an iterator object containing elements of values of storage for multiple media assets.

At line 606, control circuitry 304 iterates through the various instances of mobile devices in the home network. If only a single instance is available, the loop will only execute once. This loop may be implemented in multiple fashions depending on the choice of hardware and software language used to implement the algorithm of FIG. 6; for example, this may be implemented as part of a “for” or “while” loop.

At line 607, control circuitry 304 stores the value of the storage required for the media asset into a temporary variable “A.” In some embodiments the value of the storage required for the media asset will be stored as part of a larger data structure or class, and the value of the storage required for the media asset may be obtained through appropriate accessor methods. In some embodiments, the value of the storage required for the media asset may be converted from a string or other non-numeric data type into a numeric data type by means of an appropriate hashing algorithm. In some embodiments, control circuitry 304 may call a function to perform a comparison of the storage required for the media asset to the storage available at the mobile device. In some embodiments, the storage required for the media asset may be encoded as a primitive data structure, and rather than using a temporary variable, the storage required for the media asset may be directly used in the comparisons at line 609.

At line 608, control circuitry 304 stores the value of the storage available at the mobile device into a temporary variable “B.” Similar to the storage required for the media asset, in some embodiments, the value of storage available at the mobile device will be stored as part of a larger data structure or class, and the value of storage available at the mobile device may be obtained through accessor methods. In some embodiments, the storage available at the mobile device may be converted from a string or other non-numeric data type into a numeric data type by means of an appropriate hashing algorithm, or the storage available at the mobile device may be a primitive data structure, and may be directly used in the comparisons at lines 609 and 611.

At line 609, control circuitry 304 compares the value of A (the storage required for the media asset) to the value of B (the storage available at the mobile device) to determine if A is less than or equal to B.

If the condition in line 609 is satisfied, at line 610, control circuitry 304 executes a subroutine to retrieve the media asset and transfer the media asset to the mobile device using processing circuitry if the condition in line 609 is satisfied. In some embodiments this may be achieved by processing circuitry 306 sending the appropriate signals to the processing circuitry. At line 611, control circuitry 304 breaks out of the loop because the condition in line 609 has already been satisfied.

At line 612, control circuitry 304 executes a subroutine to return status of the request to cache the media asset using the processing circuitry.

At line 614, control circuitry 304 runs a termination subroutine after the algorithm has performed its function. For example, in some embodiments control circuitry 304 may destruct variables, perform garbage collection, free memory or clear the cache of processing circuitry 306.

It will be evident to one skilled in the art that process 600 described by the pseudocode in FIG. 6 may be implemented in any number of programming languages and a variety of different hardware, and the particular choice and location of primitive functions, logical evaluations, and function evaluations are not intended to be limiting. It will also be evident that the code may be refactored or rewritten to manipulate the order of the various logical evaluations, perform several iterations in parallel rather than in a single iterative loop, or to otherwise manipulate and optimize run-time and performance metrics without fundamentally changing the inputs or final outputs. For example, in some embodiments break conditions may be placed after lines 610 and 612 to speed operation, or the conditional statements may be replaced with a case-switch. In some embodiments, rather than iterating over all instances of mobile devices in the home network at step 506, in some embodiments the code may be rewritten so control circuitry 304 is instructed to evaluate multiple instances of mobile devices in the home network simultaneously on a plurality of processors or processor threads, lowering the number of iterations needed and potentially speeding up computation time.

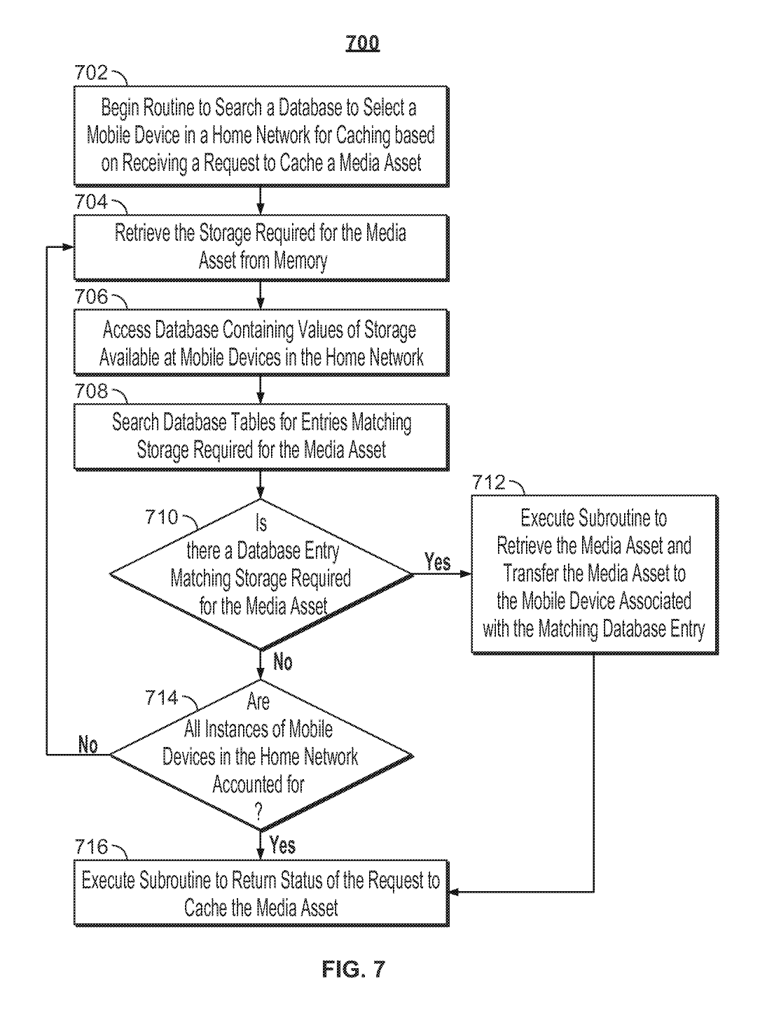

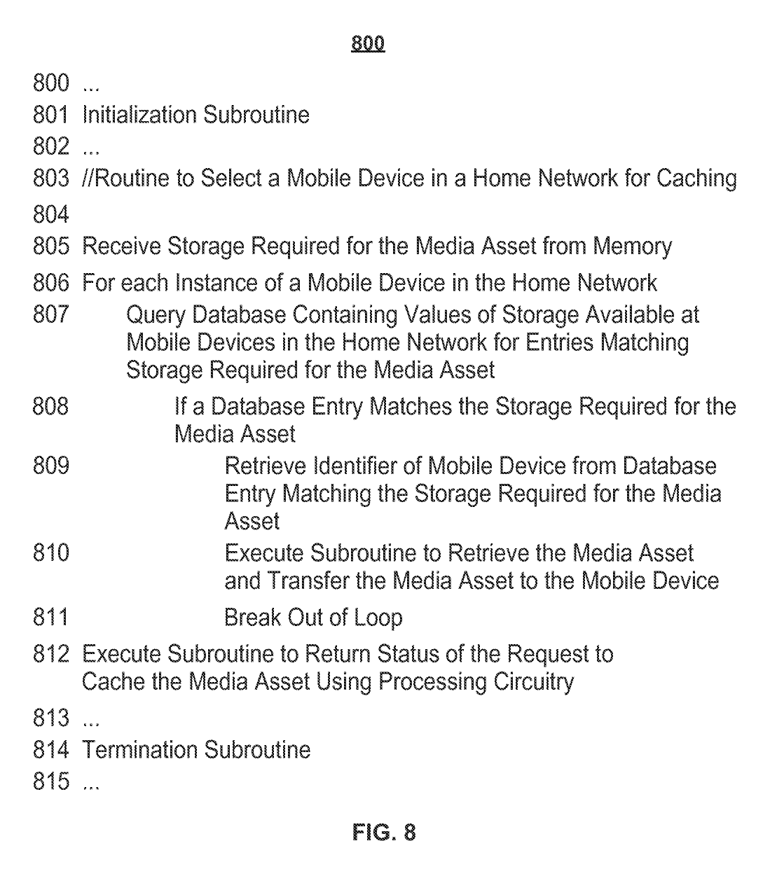

FIGS. 7 and 8 present processes implemented on control circuitry (e.g., control circuitry 304) to select a mobile device in a home network for caching using a database containing information regarding mobile devices available in the home network in accordance with some embodiments of the disclosure. Similar to the algorithms described by FIGS. 5 and 6, in some embodiments this process may be encoded on to non-transitory storage medium (e.g., storage device 308) as a set of instructions to be decoded and executed by processing circuitry (e.g., processing circuitry 306). Processing circuitry may in turn provide instructions to other sub-circuits contained within control circuitry 304, such as the tuning, video generating, encoding, decoding, encrypting, decrypting, scaling, analog/digital conversion circuitry, and the like.

The flowchart in FIG. 7 describes a process implemented on control circuitry (e.g., control circuitry 304) to search a database and select a mobile device in the home network for caching in accordance with some embodiments of the disclosure.

At step 702, control circuitry 304 to search a database and select a mobile device in the home network for caching will begin based on receiving a request to cache a media asset. In some embodiments, this may be done either directly or indirectly in response to a user action or input (e.g., from signals received by control circuitry 304 or user input interface 310).

At step 704, control circuitry 304 proceeds to retrieve the storage required for the media asset from memory. In some embodiments control circuitry 304 may retrieve a single primitive data structure that represents storage required for the media asset. In some embodiments, control circuitry 304 may retrieve the value from a larger class or data structure.

At step 706, control circuitry 304 accesses a database containing information regarding mobile devices available in the home network, particularly values of storage available at the mobile devices. In some embodiments, this database may be stored locally (e.g., on storage device 308) prior to beginning the algorithm. In some embodiments the database may also be accessed by using communications circuitry to transmit information across a communications network (e.g., communications network 414) to a database implemented on a remote storage device (e.g., media guidance data source 418).

At step 708, control circuitry 304 searches database tables for entries matching the storage required for the media asset. In some embodiments this may be done by comparing an identifier, for example a string or integer representing the storage required for the media asset that matches the types of identifiers used inside the database. In some embodiments control circuitry 304 may submit a general query to the database for table entries matching the storage required for the media asset. Control circuitry 304 may receive a list of indices or a data structure containing a portion of the database contents. In some embodiments the database may implement a junction table that in turn cross-references entries from other databases. In this case, control circuitry 304 may retrieve indices from a first database that in turn can be used to retrieve information from a second database. Although we may describe control circuitry 304 interacting with a single database for purposes of clarity, it is understood that the algorithm of FIG. 7 may be implemented using multiple independent or cross-referenced databases.

At step 710, control circuitry 304 determines if there are database entries matching the storage required for the media asset. In some embodiments, control circuitry 304 may receive a signal from the database indicating that there are no matching entries. In some embodiments, control circuitry 304 may instead receive a list of indices or data structures with a NULL or dummy value. If control circuitry 304 identifies that there are database entries matching the storage required for the media asset, the algorithm proceeds to step 712; otherwise the algorithm proceeds to step 714.

At step 712, control circuitry 304 executes a subroutine to retrieve the media asset and transfer the media asset to the mobile device associated with the matching database entry. Afterwards, the algorithm may proceed to step 716 where control circuitry 304 executes a subroutine to return status of the request to cache the media asset.

At step 714, control circuitry 304 determines if all instances of mobile devices in the home network are accounted for and if further iterations are needed. If further iterations are needed the algorithm will loop back to step 704 where control circuitry 304 will retrieve the storage required for the media asset. If no further iterations are needed the algorithm will proceed to step 716.

At step 716, control circuitry 304 executes a subroutine to return status of the request to cache the media asset.

It is contemplated that the descriptions of FIG. 7 may be used with any other embodiment of this disclosure. In addition, the descriptions described in relation to process 700 of FIG. 7 may be done in alternative orders or in parallel to further the purposes of this disclosure. For example, control circuitry 304 may submit multiple queries to the database in parallel, or it may submit multiple queries to a plurality of similar databases in order to reduce lag and speed the execution of process 700. Furthermore, it should be noted that the process of FIG. 7 may be implemented on a combination of appropriately configured software and hardware, and that any of the devices or equipment discussed in relation to FIGS. 3-4 could be used to implement one or more portions of the algorithm.

The pseudocode in FIG. 8 describes a process to select a mobile device in a home network for caching in accordance with some embodiments of the disclosure. It will be evident to one skilled in the art that process 800 described by the pseudocode in FIG. 8 may be implemented in any number of programming languages and a variety of different hardware, and that the style and format should not be construed as limiting, but rather a general template of the steps and procedures that would be consistent with code used to implement some embodiments of this disclosure.

At line 801, control circuitry 304 runs a subroutine to initialize variables and prepare to select a mobile device in a home network for caching, which begins on line 805. For example, in some embodiments, control circuitry 304 may copy instructions from non-transitory storage medium (e.g., storage device 308) into RAM or into the cache for processing circuitry 306 during the initialization stage.

At line 805, control circuitry 304 receives a value of the storage required for the media asset. In some embodiments these instances may be retrieved from memory.

At line 806, control circuitry 304 iterates through the various instances of mobile devices in the home network. If only a single instance is available, the loop will only execute once. This loop may be implemented in multiple fashions depending on the choice of hardware and software language used to implement the algorithm of FIG. 8; for example, this may be implemented as part of a “for” or “while” loop, in some programming languages. In some embodiments it may be convenient to store the instances of mobile devices in the home network in a single class or encapsulated data structure that will perform the loop as part of an internal method.

At line 807, control circuitry 304 queries a database for entries matching the storage required for the media asset. Depending on how the database is implemented and how the storage required for the media asset is stored, an intermittent step may be required to convert the storage required for the media asset into a form consistent with the database. For example, the storage required for the media asset may be encoded into a string or an integer using an appropriate hashing algorithm prior to being transmitted to the database by control circuitry 304 as part of a query. In some embodiments, the storage required for the media asset may be encoded as a primitive data structure, and control circuitry 304 may submit the storage required for the media asset as a query to the database directly. After querying the database, control circuitry 304 may receive a set of database entries matching the storage required for the media asset. In some embodiments control circuitry 304 may receive these entries in the form of a data-structure, a set of indices of the database, or a set of indices of another cross-referenced database.

At line 808, control circuitry 304 will determine if there are any database entries matching the storage required for the media asset. In some embodiments control circuitry 304 may determine this by checking if the database returned an empty data structure or a NULL value in response to the query in line 807. If there are matching database entries the algorithm may proceed to line 809. If there were no matching database entries the algorithm may instead proceed to line 812.

At line 809, control circuitry 304 retrieves an identifier for a mobile device database entry from the database entries matching the storage required for the media asset. For example, if control circuitry 304 retrieves a list of indices after querying the database in line 807, in some embodiments control circuitry 304 may retrieve the mobile device database entries located at the received indices. In some embodiments, the indices may point to a larger data structure contained within the database, and control circuitry 304 may retrieve the identifier for the mobile device within the data structure using appropriate accessor methods. In some embodiments, control circuitry 304 may retrieve the identifier for the mobile device and store the identifier in a separate data structure locally (e.g., in storage 308) prior to proceeding further. After retrieving the identifier for the mobile device the algorithm will proceed to line 810.

At line 810, control circuitry 304 executes a subroutine to use the identifier of the mobile device and execute a subroutine to retrieve the media asset and transfer the media asset to the mobile device using processing circuitry. Afterwards, the algorithm may proceed to line 811. At line 811, control circuitry 304 breaks out of the loop because the condition in line 808 has already been satisfied.

At line 812, control circuitry 304 executes a subroutine to return status of the request to cache the media asset using the processing circuitry. Afterwards, the algorithm may proceed to line 814.

At line 814, control circuitry 304 executes a termination subroutine after the algorithm has performed its function and all instances of mobile devices in the home network have been processed and checked against the database. For example, in some embodiments control circuitry 304 may destruct variables, perform garbage collection, free memory or clear the cache of processing circuitry 306.

It will be evident to one skilled in the art that process 800 described by the pseudocode in FIG. 8 may be implemented in any number of programming languages and a variety of different hardware, and the particular choice and location of primitive functions, logical evaluations, and function evaluations are not intended to be limiting. It will also be evident that the code may be refactored or rewritten to manipulate the order of the various logical evaluations, perform several iterations in parallel rather than in a single iterative loop, or to otherwise manipulate and optimize run-time and performance metrics without fundamentally changing the inputs or final outputs. For example, in some embodiments the code may be re-written so control circuitry 304 is instructed to evaluate multiple instances of mobile devices in the home network and submit multiple database queries simultaneously using a plurality of processors or processor threads. It is also understood that although we may describe control circuitry 304 interacting with a single database, this is only a single embodiment described for illustrative purposes, and the algorithm of FIG. 8 may be implemented using multiple independent or cross-referenced databases. For example, a database stored locally (e.g., on storage 308) may index or cross-reference a database stored remotely (e.g., media guidance data source 418), which may be accessible through any number of communication channels (e.g., communications network 414). In some embodiments, this may allow control circuitry 304 to utilize a look-up table or database front-end efficiently stored on a small local drive to access a larger database stored on a remote server on demand.

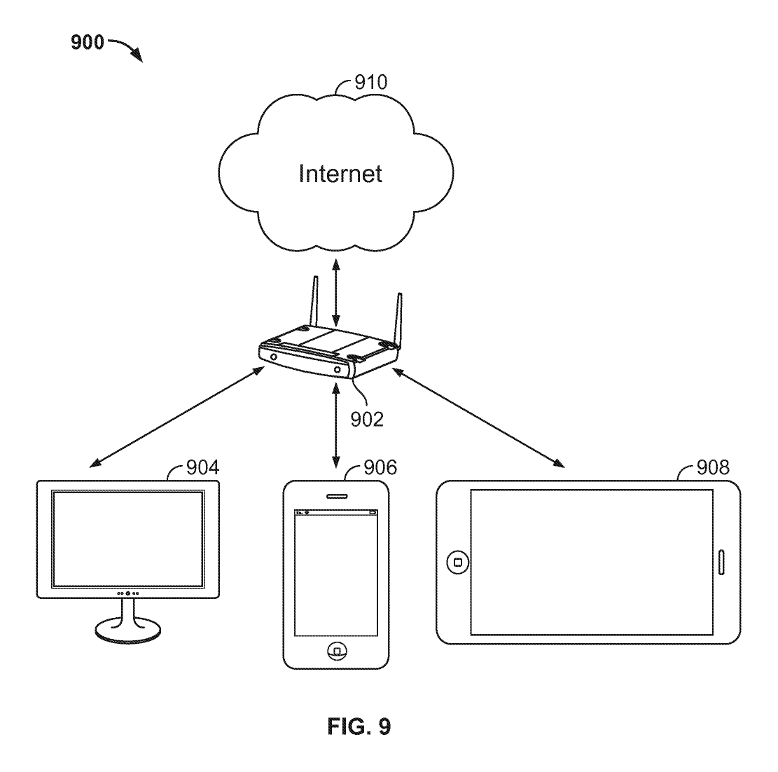

FIG. 9 is a block diagram of a system 900 for caching media assets in a home network in accordance with some embodiments of the disclosure. System 900 includes an embodiment of user equipment device 300, such as smart television 904. The interactive media guidance application, implemented on smart television 904, may receive an instruction to store some frequently needed data, data the user is expected to access, or other data suitable for caching. After smart television 904's memory is full, the interactive media guidance application may search for personal devices 906 and 908 in the home network implemented via network router 902 to cache data and improve the user's viewing experience. Alternatively, the interactive media guidance application may search for personal devices 906 and 908 in the home network before smart television 904's memory is full. The home network may be connected to Internet 910 via network router 902.

In some embodiments, as the user is setting up smart television 904 within their home network, the interactive media guidance application implemented on smart television 904 may detect mobile device 906 and tablet device 908 in the user's Wi-Fi network. The interactive media guidance application may prompt the user to allow use of memory on one or both devices, e.g., 500 MB of memory from each of those devices, to store data, such as poster art and movie trailers. The user may be especially motivated to consent to the prompt if they have issues with buffering media content from the distant media server.

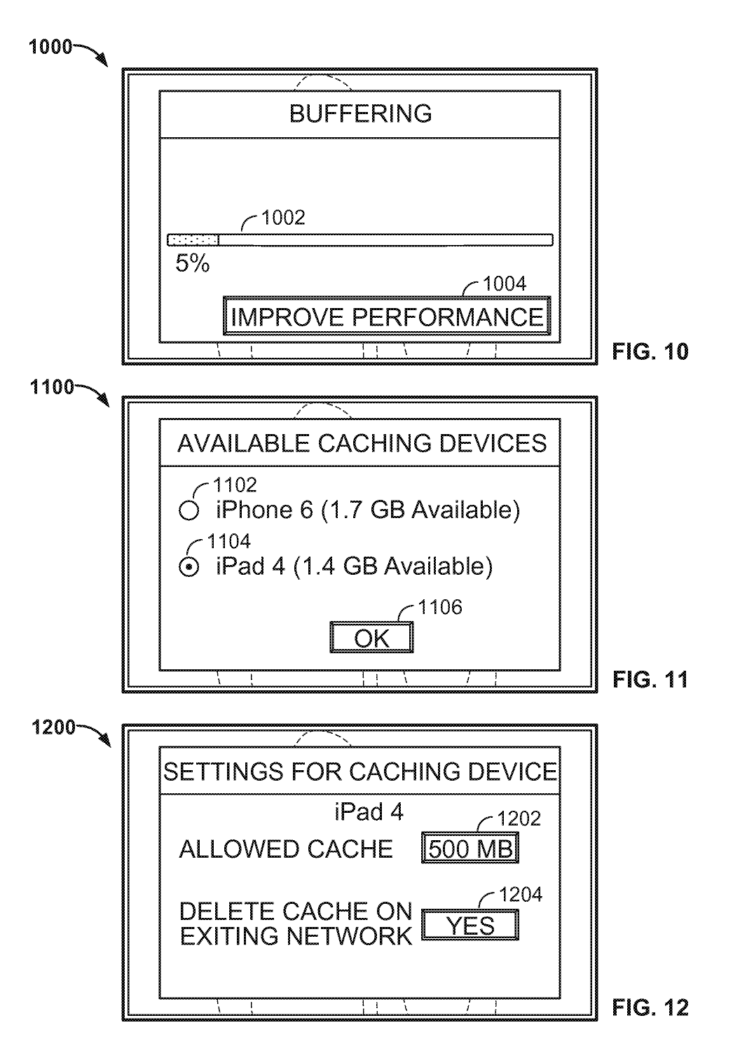

FIGS. 10-12 are diagrams of displays relating to caching media assets in a home network in accordance with some embodiments of the disclosure. As discussed with respect to FIG. 9, after smart television 904's memory is full, the interactive media guidance application may search for potential caching devices in the home network to cache data and improve the user's viewing experience. Alternatively, the interactive media guidance application may search for potential caching devices in the home network before smart television 904's memory is full. FIG. 10 shows illustrative display 1000 where smart television 904's memory is full and therefore can no longer cache data. When the user attempts to retrieve a media asset for viewing, the buffering progress indicated by progress bar 1002 may be too slow for the user to view the media asset in a reasonable period of time. Since local memory in smart television 904 is full, it can no longer cache any data in advance. The interactive media guidance application provides option 1004 to improve performance. For example, the interactive media guidance application may improve performance by searching for potential caching devices on the user's home network.

FIG. 11 shows illustrative display 1100 where the interactive media guidance application offers options 1102 and 1104 for selecting a caching device. In some embodiments, the home network implements a standard Wi-Fi protocol. The user equipment device and the mobile device each include a custom application that allows a first device on the home network to query a second device for an amount of storage space available on the second device. The interactive media guidance application generates a query for retrieving the amount of storage available on the mobile device via the custom application on the user equipment device. The interactive media guidance application transmits the query to the custom application on the mobile device from the custom application on the user equipment device.

For example, the interactive media guidance application communicates with potential caching devices, such mobile device 906 and tablet device 908, in the user's wireless network via, e.g., the IEEE 802.11 protocol or another suitable wireless networking protocol. In the case of the IEEE 802.11 protocol, the wireless protocol includes a specification for implementing wireless local area network communication in wireless frequency bands, such as 2.4 GHz, 3.6 GHz, 5 GHz, 60 GHz, or another suitable frequency band. The security features of the IEEE 802.11 protocol may not allow the interactive media guidance application to query potential caching devices for information to determine suitability of the caching device, such as available storage space, calendar information, or other suitable information. In some embodiments, the user installs a software application on, e.g., mobile device 906, connected to the user's home network. The software application may be paired with, e.g., smart television 904, running the interactive media guidance application. The software application may request the necessary permissions from the user to retrieve information needed to determine suitability for caching. The interactive media guidance application may communicate with the software application to retrieve this information.

In some embodiments, the custom application is installed on the mobile device via an Internet connection. In some embodiments, the custom application is installed on the mobile device via a physical connection to the user equipment device. For example, the interactive media guidance application, running on smart television 904, prompts the user to designate a caching device and requests the user to connect mobile device 906 to smart television 904 via a physical connection, e.g., using a universal serial bus (USB) port or another suitable interface. The interactive media guidance application may install a software application on mobile device 906. The interactive media guidance application may communicate with the software application to retrieve information needed to determine suitability for caching. After the software application is installed on mobile device 906, the interactive media guidance application may communicate with the software application via the user's home network. The physical connection between smart television 904 and the mobile device 906 may be severed in this case.

In some embodiments, the home network implements a custom Wi-Fi protocol. The custom Wi-Fi protocol allows a first device on the home network to query a second device for an amount of storage space available on the second device. The user equipment device and the mobile device each include a software driver compatible with the custom Wi-Fi protocol. The interactive media guidance application generates a query for retrieving the amount of storage available on the mobile device according to the custom Wi-Fi protocol. The interactive media guidance application transmits the query to the mobile device.

For example, the user's home network sets up communication between smart television 904 and mobile device 906 via a custom wireless protocol. The 802.11 wireless protocol may be modified to allow smart television 904 to retrieve information from mobile device 906 needed to determine suitability of the mobile device for caching. Such a non-IEEE standard 802.11 feature extends functionality of the 802.11 wireless protocol and may be implemented as a proprietary feature. For example, chipmaker ATHEROS implemented a proprietary channel bonding feature for manufacturers of access points and client cards for boosting network speeds and increased network range. The custom wireless protocol may allow the interactive media guidance application to retrieve needed information from mobile device 906 without installing a software application on the mobile device. The custom wireless protocol may limit access of such information to verified entities, such as the interactive media guidance application, and deny requests from other unverified entities.

After the interactive media guidance application queries mobile device 906 and tablet device 908 in the user's home network for their available storage space, display 1100 is updated to include this information as indicated in options 1102 and 1104. In the illustrative display, mobile device 906 is an IPHONE 6 with 1.7 GB of available storage, and tablet device 908 is an IPAD 4 with 1.4 GB of available storage. After the user selects an option and selects button 1106, the interactive media guidance application may proceed to display 1200 illustrated in FIG. 12.

FIG. 12 shows illustrative display 1200 including settings for a caching device selected from illustrative display 1100. In some embodiments, illustrative display 1200 is shown in response to a selection from another display screen or user input. The interactive media guidance application allows the user to set a maximum allowed cache size via option 1202. By selecting a certain limit for the cache size, e.g., 500 MB, the user may use the selected device for caching but also ensure that the function of the device itself does not suffer due to low memory availability. The interactive media guidance application may use the allowed cache memory to store data, such as poster art and movie trailers.

In some embodiments, the interactive media guidance application transmits an instruction to the mobile device to delete the second portion of the media asset when the mobile device disconnects from the home network. In FIG. 12, the interactive media guidance application may allow the user to select an option to delete the cache on the selected device when exiting the network via option 1204. The data stored on the caching device may be removed when the caching device leaves the user's home network to maintain security of any important information, such as the user's identification. If an authorized entity were to attempt to access the cached data after the device has left the user's home network, such an entity will be unable to retrieve any such information. For example, the user may take mobile device 906 out of the home network and lose mobile device 906 while away from the home. In such a case, any unauthorized entity attempting to access the cached data on mobile device 906 may not be able to retrieve any important information that was potentially stored in the cached data.

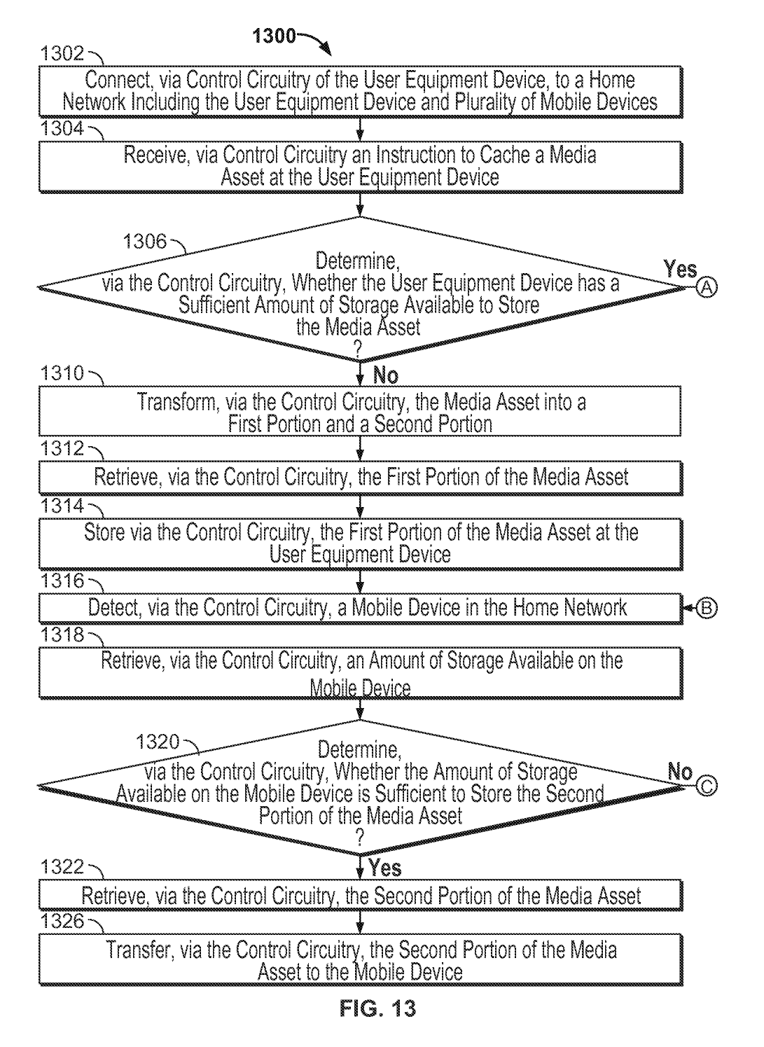

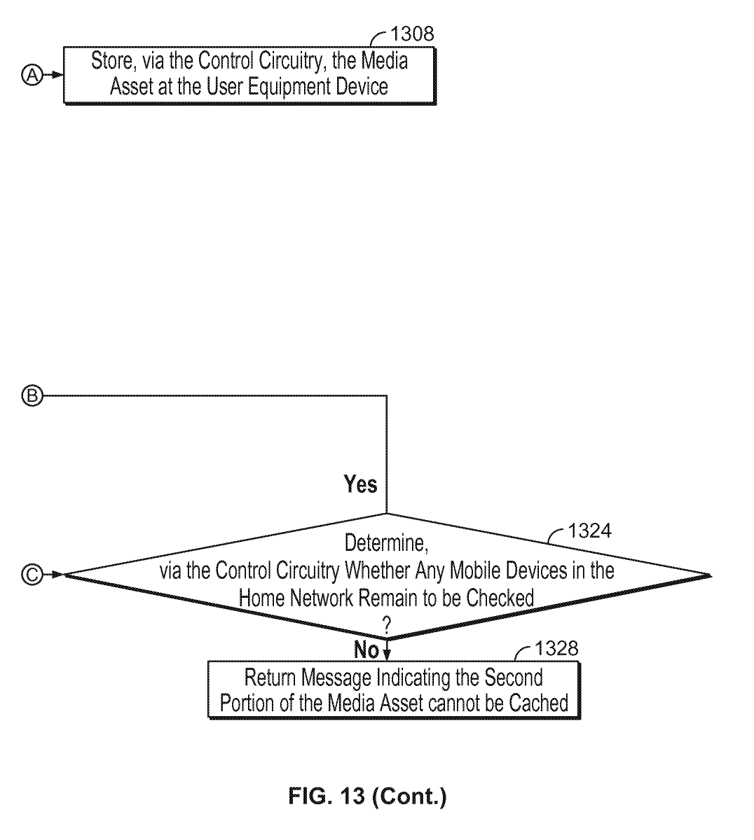

FIG. 13 is a flowchart of illustrative process 1300 for caching media assets in a home network in accordance with some embodiments of the disclosure. It should be noted that process 1300 or any step thereof could be performed on, or provided by, any of the devices shown in FIGS. 3-4 and 9. For example, process 1300 may be executed by control circuitry 304 (FIG. 3) as instructed by an interactive media guidance application implemented on user equipment 402, 404, and/or 406 (FIG. 4) or smart television 904 (FIG. 9). In addition, one or more steps of process 1300 may be incorporated into or combined with one or more steps of any other process or embodiment (e.g., FIGS. 5-8 and 14).

The interactive media guidance application is implemented on control circuitry, e.g., control circuitry 304, of a user equipment device, e.g., user equipment device 300 connected to a home network. The home network includes a user equipment device, e.g., user equipment device 300 or smart television 904, and one or more mobile devices, e.g., mobile device 906 and tablet device 908. At step 1302, the interactive media guidance application connects to the home network. At step 1304, the interactive media guidance application receives an instruction to cache a media asset at the user equipment device, e.g., smart television 904. At step 1306, the interactive media guidance application determines whether the user equipment device, e.g., smart television 904, has a sufficient amount of storage available to store the media asset.

If the interactive media guidance application determines that there is sufficient storage available on the user equipment device, e.g., smart television 904, at step 1308, the interactive media guidance application stores the media asset at the user equipment device. If the interactive media guidance application determines that the user equipment device does not have sufficient storage available to store the media asset, at step 1310, the interactive media guidance application transforms the media asset into a first portion and a second portion. In some embodiments, the interactive media guidance application designates one or more segments of the media asset likely to be accessed as the first portion. The interactive media guidance application designates one or more segments of the media asset not likely to be accessed as the second portion. At step 1312, the interactive media guidance application retrieves the first portion of the media asset. At step 1314, the interactive media guidance application stores the first portion of the media asset at the user equipment device, e.g., smart television 904. At step 1316, the interactive media guidance application detects a mobile device, e.g., mobile device 906, in the home network. At step 1318, the interactive media guidance application retrieves an amount of storage available on the mobile device. At step 1320, the interactive media guidance application determines whether the amount of storage available on the mobile device is sufficient to store the second portion of the media asset.

If the amount of storage available on the mobile device is sufficient, at step 1322, the interactive media guidance application retrieves the second portion of the media asset. At step 1326, the interactive media guidance application transfers the second portion of the media asset to the mobile device, e.g., mobile device 906. If the amount of storage available on the mobile device is not sufficient, at step 1324, the interactive media guidance application determines whether any mobile devices in the home network remain to be checked, e.g., tablet device 908. If a mobile device in the home network remains to be checked, the interactive media guidance application returns to step 1316 and detects the mobile device in the home network. If no mobile devices in the home network remain to be checked, the interactive media guidance application proceeds to step 1328 and returns a message indicating that the second portion of the media asset cannot be cached.

It is contemplated that the steps or descriptions of FIG. 13 may be used with any other embodiment of this disclosure. In addition, the steps and descriptions described in relation to FIG. 13 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 and 9 could be used to perform one or more of the steps in FIG. 13.

In some embodiments, the interactive media guidance application determines availability of a caching device, e.g., mobile device 906 or tablet device 908, in the user's home network. For example, the interactive media guidance application may periodically send a ping request to the caching device to detect whether it is present in the user's home network. If the caching device does not return a response to the ping request, the interactive media guidance application may store an indication that the caching device is unavailable. If the caching device returns a response to the ping request, the interactive media guidance application may store an indication that the caching device is available.

The interactive media guidance application may store data, such as guidance data or media content, on the caching device based on its availability. For example, after monitoring availability of the caching device for a certain period of time, the interactive media guidance application may determine that the caching device is only available during the day. The interactive media guidance application may send instructions to only store data on the caching device that is needed during the day. In another example, after monitoring availability of the caching device for a certain period of time, the interactive media guidance application may determine that the caching device is only available during the night. The interactive media guidance application may send instructions to only store data on the caching device that is needed during the night.

In yet another example, the interactive media guidance application may receive calendar information from a caching device, such as a mobile device, in the user's home network. The interactive media guidance application may determine whether to store data, such as guidance data or media content, on the caching device based on its availability in the calendar information. For example, if the calendar information indicates that the user is going to be at an event during a certain time, the interactive media guidance application may not store data needed during that time on the mobile device. In another example, if the calendar information indicates that the user is going to be at home during a certain time, the interactive media guidance application may store data needed during that time on the mobile device.

For example, the interactive media guidance application may detect the user's mobile device 906 and tablet device 908 in the home network. The interactive media guidance application may determine that tablet device 908 is always available in the home network, e.g., because the user does not carry tablet device 908 outside of the home. On the other hand, the interactive media guidance application may determine that mobile device 906 is only available in the home network during nights and weekends, e.g., because the user carries mobile device 906 with them during the day at work. The interactive media guidance application may store data needed at night or on the weekends in mobile device 906, while the interactive media guidance application may store data needed during the day or data needed at a later unspecified time (e.g., the user is expected to watch a particular program at some later time) in tablet device 908. In this manner, the interactive media guidance application may choose the caching device based on the availability of the caching device as well as the persistence of the data being stored, i.e., whether the data is being stored for short-term or long-term usage or whether the data is more or less likely to be accessed at a given time.

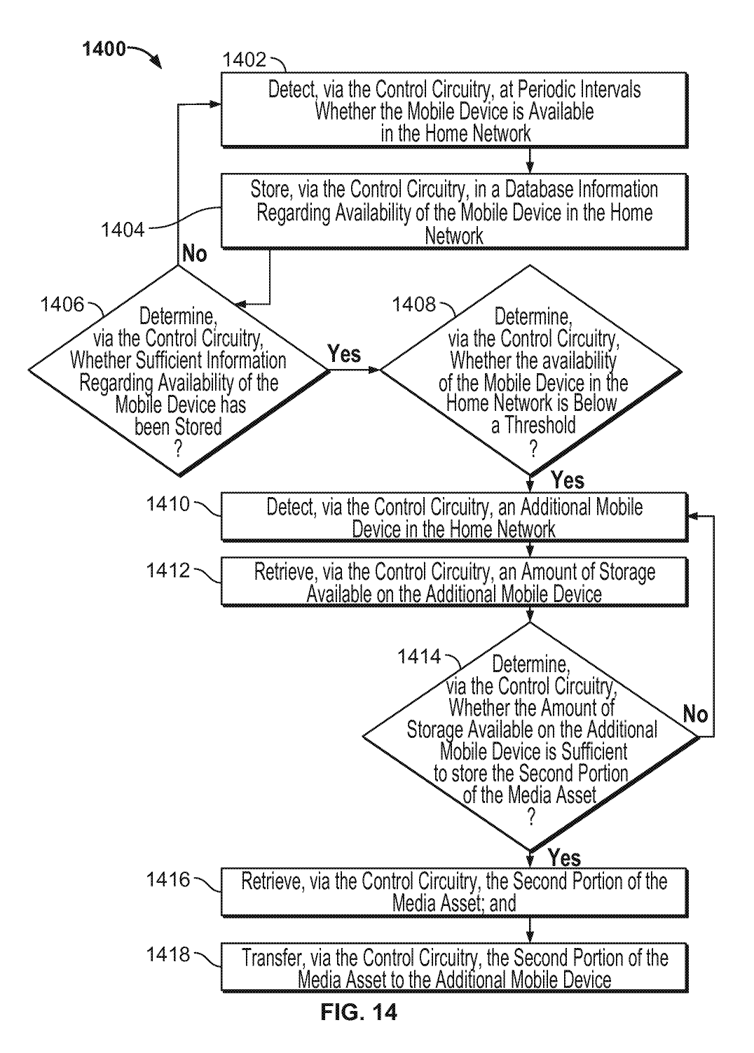

FIG. 14 is a flowchart of illustrative process 1400 for caching media assets based on availability of the caching device in a home network in accordance with some embodiments of the disclosure. Process 1400 may build on process 1300 by considering availability of the mobile device, e.g., mobile device 906, when determining whether to store the second portion of the media asset at the mobile device. It should be noted that process 1400 or any step thereof could be performed on, or provided by, any of the devices shown in FIGS. 3-4 and 9. For example, process 1400 may be executed by control circuitry 304 (FIG. 3) as instructed by an interactive media guidance application implemented on user equipment 402, 404, and/or 406 (FIG. 4) or smart television 904 (FIG. 9). In addition, one or more steps of process 1400 may be incorporated into or combined with one or more steps of any other process or embodiment (e.g., FIGS. 5-8 and 13).

At step 1402, the interactive media guidance application detects at periodic intervals whether the mobile device, e.g., mobile device 906, is available in the home network. At step 1404, the interactive media guidance application stores in a database information regarding availability of the mobile device, e.g., mobile device 906, in the home network. At step 1406, the interactive media guidance application determines whether sufficient information regarding availability of the mobile device, e.g., mobile device 906, has been stored. For example, the interactive media guidance application may need to collect information regarding availability for 24 hours to be considered sufficient information. If sufficient information regarding availability of the mobile device has yet not been stored, the interactive media guidance application returns to step 1402 to detect at periodic intervals whether the mobile device, e.g., mobile device 906, is available in the home network.

If sufficient information regarding availability of the mobile device has been stored, at step 1408, the interactive media guidance application determines whether the availability of the mobile device, e.g., mobile device 906, in the home network is below a threshold. For example, the threshold may be related to an expected time when the cached media asset will be retrieved from the mobile device. If the availability of the mobile device in the home network is not below the threshold (e.g., the mobile device is sufficiently available for retrieving cached data), the interactive media guidance application retrieves an amount of storage available on the mobile device and accordingly retrieves and transfers the second portion of the media asset to the mobile device (e.g., following steps 1318-1326 in FIG. 13). If the availability of the mobile device in the home network is below the threshold (e.g., the mobile device is not sufficiently available for retrieving cached data), at step 1410, the interactive media guidance application detects an additional mobile device, e.g., tablet device 908, in the home network. The interactive media guidance application may gather information regarding availability of the additional mobile device as well.

At step 1412, the interactive media guidance application retrieves an amount of storage available on the additional mobile device, e.g., tablet device 908. At step 1414, the interactive media guidance application determines whether the amount of storage available on the additional mobile device, e.g., tablet device 908, is sufficient to store the second portion of the media asset. If the amount of storage available is not sufficient to store the second portion of the media asset, the interactive media guidance application returns to step 1410 to detect another mobile device in the home network. If the amount of storage available is sufficient to store the second portion of the media asset, at step 1416, the interactive media guidance application retrieves the second portion of the media asset. At step 1418, the interactive media guidance application transfers the second portion of the media asset to the additional mobile device, e.g., tablet device 908.

It is contemplated that the steps or descriptions of FIG. 14 may be used with any other embodiment of this disclosure. In addition, the steps and descriptions described in relation to FIG. 14 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 and 9 could be used to perform one or more of the steps in FIG. 14.

The above-described embodiments of the present disclosure are presented for purposes of illustration and not of limitation, and the present disclosure is limited only by the claims that follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted, the systems and/or methods described above may be applied to, or used in accordance with, other systems and/or methods.

1. A method for caching media assets implemented on a user equipment device connected to a home network including the user equipment device and a mobile device, comprising:
receiving, via control circuitry of the user equipment device, an instruction to cache a media asset at the user equipment device;
determining, via the control circuitry, whether the user equipment device has a sufficient amount of storage available to store the media asset; and
in response to determining that the user equipment device does not have the sufficient amount of storage available to store the media asset:
transforming, via the control circuitry, the media asset into a first portion and a second portion;
retrieving, via the control circuitry, the first portion of the media asset;
storing, via the control circuitry, the first portion of the media asset at the user equipment device;
detecting, via the control circuitry, the mobile device in the home network;
retrieving, via the control circuitry, an amount of storage available on the mobile device;
determining, via the control circuitry, whether the amount of storage available on the mobile device is sufficient to store the second portion of the media asset; and
in response to determining that the amount of storage available is sufficient to store the second portion of the media asset:
retrieving, via the control circuitry, the second portion of the media asset; and
transferring, via the control circuitry, the second portion of the media asset to the mobile device

2. The method of claim 1, wherein:
the home network implements a custom Wi-Fi protocol, wherein the custom Wi-Fi protocol allows a first device on the home network to query a second device for an amount of storage space available on the second device;
the user equipment device and the mobile device each include a software driver compatible with the custom Wi-Fi protocol; and
the retrieving, via the control circuitry, the amount of storage available on the mobile device comprises:
generating, via the control circuitry, a query for retrieving the amount of storage available on the mobile device according to the custom Wi-Fi protocol; and
transmitting, via the control circuitry, the query to the mobile device.

3. The method of claim 1, wherein:
the home network implements a standard Wi-Fi protocol;
the user equipment device and the mobile device each include a custom application that allows a first device on the home network to query a second device for an amount of storage space available on the second device; and
the retrieving, via the control circuitry, the amount of storage available on the mobile device comprises:
generating, via the control circuitry, a query for retrieving the amount of storage available on the mobile device via the custom application on the user equipment device; and
transmitting, via the control circuitry, the query to the custom application on the mobile device from the custom application on the user equipment device.

4. The method of claim 3, wherein the custom application is installed on the mobile device via an Internet connection.

5. The method of claim 3, wherein the custom application is installed on the mobile device via a physical connection to the user equipment device.

6. The method of claim 1, further comprising:
detecting, via the control circuitry, at periodic intervals whether the mobile device is available in the home network;
storing, via the control circuitry, in a database information regarding availability of the mobile device in the home network;
determining, via the control circuitry, whether the availability of the mobile device in the home network is below a threshold;
in response to determining that the availability of the mobile device in the home network is below the threshold:
detecting, via the control circuitry, an additional mobile device in the home network;
retrieving, via the control circuitry, an amount of storage available on the additional mobile device;
determining, via the control circuitry, whether the amount of storage available on the additional mobile device is sufficient to store the second portion of the media asset; and
in response to determining that the amount of storage available is sufficient to store the second portion of the media asset:
retrieving, via the control circuitry, the second portion of the media asset; and
transferring, via the control circuitry, the second portion of the media asset to the additional mobile device.

7. The method of claim 1, further comprising:
detecting, via the control circuitry, at periodic intervals whether the mobile device is available in the home network;
storing, via the control circuitry, in a database information regarding availability of the mobile device in the home network;
determining, via the control circuitry, whether the availability of the mobile device in the home network exceeds a threshold; and
transferring, via the control circuitry, the second portion of the media asset to the mobile device in response to determining that the availability of the mobile device in the home network exceeds the threshold and that the amount of storage available is sufficient to store the second portion of the media asset.

8. The method of claim 7, wherein the threshold is related to an expected time when the cached media asset will be retrieved from the mobile device.

9. The method of claim 1, wherein transforming, via the control circuitry, the media asset into the first portion and the second portion comprises:
designating, via the control circuitry, one or more segments of the media asset likely to be accessed as the first portion; and
designating, via the control circuitry, one or more segments of the media asset not likely to be accessed as the second portion.

10. The method of claim 1, further comprising:
transmitting, via the control circuitry, an instruction to the mobile device to delete the second portion of the media asset when the mobile device disconnects from the home network.

11. A system for caching media assets implemented on a user equipment device connected to a home network including the user equipment device and a mobile device, comprising:
control circuitry configured to:
receive an instruction to cache a media asset at the user equipment device;
determine whether the user equipment device has a sufficient amount of storage available to store the media asset; and
in response to determining that the user equipment device does not have the sufficient amount of storage available to store the media asset:
transform the media asset into a first portion and a second portion;
retrieve the first portion of the media asset;
store the first portion of the media asset at the user equipment device;
detect the mobile device in the home network;
retrieve an amount of storage available on the mobile device;
determine whether the amount of storage available on the mobile device is sufficient to store the second portion of the media asset; and
in response to determining that the amount of storage available is sufficient to store the second portion of the media asset:
retrieve the second portion of the media asset; and
transfer the second portion of the media asset to the mobile device.

12. The system of claim 11, wherein:
the home network implements a custom Wi-Fi protocol, wherein the custom Wi-Fi protocol allows a first device on the home network to query a second device for an amount of storage space available on the second device;
the user equipment device and the mobile device each include a software driver compatible with the custom Wi-Fi protocol; and
the control circuitry configured to retrieve the amount of storage available on the mobile device comprises control circuitry configured to:
generate a query for retrieving the amount of storage available on the mobile device according to the custom Wi-Fi protocol; and
transmit the query to the mobile device.

13. The system of claim 11, wherein:
the home network implements a standard Wi-Fi protocol;
the user equipment device and the mobile device each include a custom application that allows a first device on the home network to query a second device for an amount of storage space available on the second device; and
the control circuitry configured to retrieve the amount of storage available on the mobile device comprises control circuitry configured to:
generate a query for retrieving the amount of storage available on the mobile device via the custom application on the user equipment device; and
transmit the query to the custom application on the mobile device from the custom application on the user equipment device.

14. The system of claim 13, wherein the custom application is installed on the mobile device via an Internet connection.

15. The system of claim 13, wherein the custom application is installed on the mobile device via a physical connection to the user equipment device.

16. The system of claim 11, further comprising control circuitry configured to:
detect at periodic intervals whether the mobile device is available in the home network;
store in a database information regarding availability of the mobile device in the home network;
determine whether the availability of the mobile device in the home network is below a threshold;
in response to determining that the availability of the mobile device in the home network is below the threshold:
detect an additional mobile device in the home network;
retrieve an amount of storage available on the additional mobile device;
determine whether the amount of storage available on the additional mobile device is sufficient to store the second portion of the media asset; and
in response to determining that the amount of storage available is sufficient to store the second portion of the media asset:
retrieve the second portion of the media asset; and
transfer the second portion of the media asset to the additional mobile device.

17. The system of claim 11, further comprising control circuitry configured to:
detect at periodic intervals whether the mobile device is available in the home network;
store in a database information regarding availability of the mobile device in the home network;
determine whether the availability of the mobile device in the home network exceeds a threshold; and
transfer the second portion of the media asset to the mobile device in response to determining that the availability of the mobile device in the home network exceeds the threshold and that the amount of storage available is sufficient to store the second portion of the media asset.

18. The system of claim 17, wherein the threshold is related to an expected time when the cached media asset will be retrieved from the mobile device.

19. The system of claim 11, wherein the control circuitry configured to transform the media asset into the first portion and the second portion comprises control circuitry configured to:
designate one or more segments of the media asset likely to be accessed as the first portion; and
designate one or more segments of the media asset not likely to be accessed as the second portion.

20. The system of claim 11, further comprising control circuitry configured to: transmit an instruction to the mobile device to delete the second portion of the media asset when the mobile device disconnects from the home network.

21-50. (canceled)
